(19) United States
(12) Patent Application Publication
(10) Pub. No.: US 2013/0047928 A1
(43) Pub. Date: Feb. 28, 2013

(54) LONG TERM PET WASTE COLLECTION DEVICE

(71) Applicant: RAUL BANASCO, Orlando, FL (US)

(72) Inventor: RAUL BANASCO, Orlando, FL (US)

(21) Appl. No.: 13/214,565

(22) Filed: Aug. 22, 2011

(51) Int. Cl. A01K 29/00

(52) U.S. Cl. 119/165

(57) ABSTRACT

A long term waste collection device for collecting and storing pet deposits includes a main body having a flat base section, and a plurality of upward facing side sections, a plurality of angled support columns positioned on the base section, a non-porous top surface having multiple openings for moving the pet deposits into an interior portion of the main body for storage, and a drain valve positioned along one of the side sections for removing the stored waste.

### BACKGROUND

### Field of the Invention

The present invention relates generally to waste disposal systems, and more particularly to a pet sanitation device for allowing a pet to repeatedly deposit waste onto a single platform over a substantial period in a sanitary manner.

With the rise of individuals living in metropolitan areas and the increase in popularity of smaller dog breeds, it has become more common for the city dwelling pet owner to opt for indoor dogs as animal companions. As cats have typically been the pet of choice for urban dwellers, several options for sanitary containment and disposal of cat waste are known. Dog owners, however, have few options when it comes to their dogs and how they can relieve themselves without traveling outdoors.

While the vast majority of city dwelling dog owners are diligent about walking their dogs before and after work, urban dogs are often left for long periods of time in apartments with no options for relieving themselves. Often dogs are penalized for eliminating indoors and the mess they leave can cause damage to flooring and leaves behind an unpleasant odor that makes living situations uncomfortable for the dog and owner alike. Conventional options such as newspapers, training pads, litter boxes and small sections of turf, provide a more sanitary option for the dog but require the owner to consistently replace or wash soiled items, and to come into direct contact with the waste.

To this end, there is a need for a pet waste collection device that can allow canines, and other pets to repeatedly relieve themselves indoors in a manner that is hygienic to both the pet and the owner, and that is environmentally friendly by not requiring replacement components.

### SUMMARY OF THE INVENTION

The present invention is directed to a waste disposal device for collecting and storing pet deposits. One embodiment of the present invention can include a main body having a flat base section, and a plurality of upward facing side sections, a plurality of angled support columns positioned on the base section, a non-porous top surface having multiple openings for moving the pet deposits into an interior portion of the main body for storage, and a drain valve positioned along one of the side sections for removing the stored waste.

Another embodiment of the present invention can include markings on the top surface for increasing the aesthetic appeal of the device.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a pet waste collection device that is useful for understanding the inventive concepts disclosed herein.

FIG. 2 is a cross sectional view of the pet waste collection device according to one embodiment of the invention.

FIG. 3 is a side view of the pet waste collection device according to one embodiment of the invention is another frontal view of a golfer using the invention.

FIG. 4 is a perspective view of the pet waste collection device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

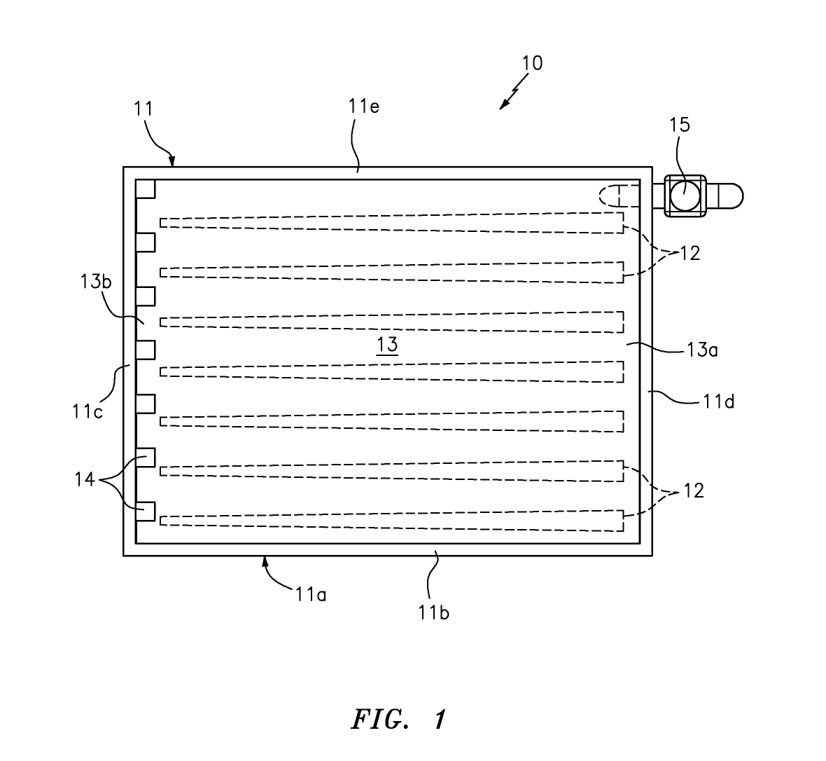

For purposes of this description, the terms “upper,” “bottom,” “right,” “left,” “front,” “vertical,” “horizontal,” and derivatives thereof shall relate to the invention as oriented in FIG. 1. Although described herein for use by canines, the inventive concepts disclosed can be equally utilized by, and applied to animals of virtually any type.

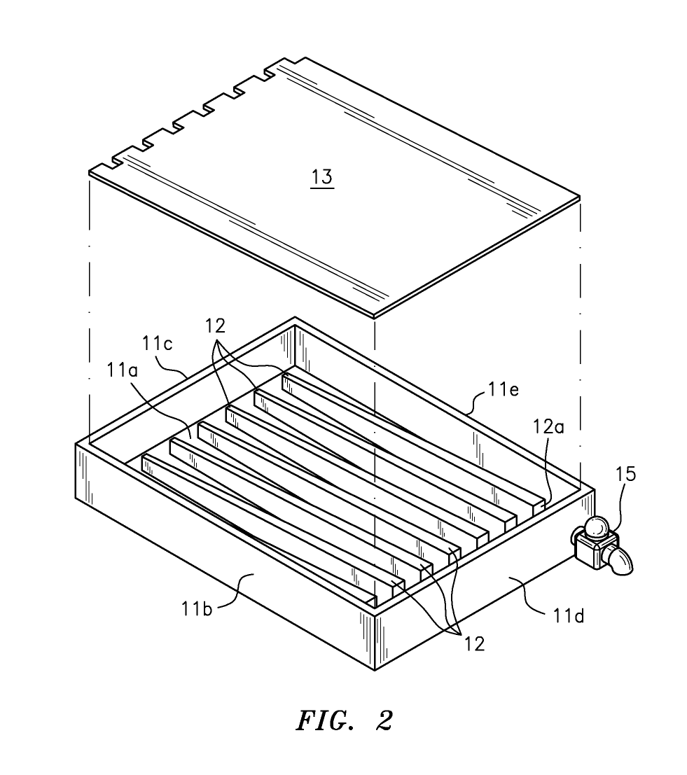

FIGS. 1-3 illustrate one embodiment of a pet waste collection device 10 that is useful for understanding the inventive concepts disclosed herein. As shown, device 10 can include a main body 11, a plurality of support rods 12 and a non-stick top surface 13.

The main body 11 can include a generally flat base member 11a, connected to a front wall 11b, a pair of opposing side walls 11c and 11d, and a back wall 11e. In one preferred embodiment, the main body 11 can include a dimension of 28″×22″×1′ and can be constructed from molded plastic having excellent durability and waterproof properties. In an alternate embodiment, however, the main body can be constructed from a single sheet of aluminum or other metallic material having bends forming the side sections. Of course, other dimensions, materials and shapes such as oval, for example, are also contemplated.

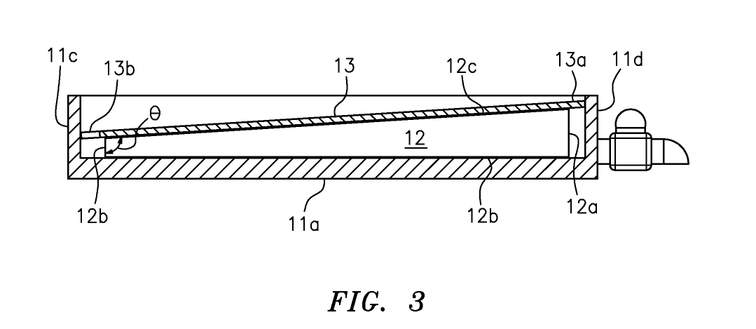

A plurality of angled support rods 12 can act to position the top surface 13 to the main body in a secure manner. To this end, each of the support rods 12 can include first and second ends 12a and 12b, a top surface 12c conventionally connected to the bottom of the non-porous top 13, and a bottom surface 12d conventionally connected to the base member 11a. As shown in FIG. 3, the first end section 12a preferably includes a length that is greater than the second end section 12b resulting in the top surface 12c having an angle Θ of approximately 5 degrees, however other angles ranging between approximately 1 and 20 degrees are also contemplated. As will be described below, this angle will act to facilitate removal of liquid waste from the non-porous top surface 13.

The top surface 13 can act as a platform for receiving bodily waste, such as urine and feces by a pet. The top surface will be secured to the top of the angled support rods 12c at angle Θ and will be bracketed on all sides by main body walls 11b, 11c, 11d and 11e, thus forming a cavernous interior with respect to base member 11a. In one embodiment, each of main body walls 11b-11e can form a raised lip around the periphery of the top surface 13, thus preventing excess liquid from overflowing out of the device 10.

In one preferred embodiment, the top surface 13 can be constructed from a single sheet of non-permeable, non-porous PVC, Polymethyl methacrylate (i.e. Plexiglas®) or other smooth plastic having an extremely low coefficient of friction and excellent stain resistant qualities. Although not illustrated, in one optional embodiment, the top surface can further include any number of unique designs or markings, such as newspaper, grass or other such art for enhancing the aesthetic appeal of the device.

Owing to the angled support rods 12, the top surface will include a high side 13a, and a low side 13b. Positioned along the periphery of the low side 13b are multiple openings 14 for diverting liquid waste into the cavernous interior.

A drain valve 15 can be positioned along one of the main body walls 11b, 11c, 11d, or 11e, for allowing a user to remove the liquid waste that has accumulated within the device. As described herein, the drain valve can include a plug or any number of known components capable of creating a removable seal/opening for accessing the stored waste.

In operation, the device 10 can be utilized in a permanent fashion by training a household pet to regularly deposit bodily waste (i.e. urine and feces) onto the top surface 13 of the device. Such a feature is advantageous for pet owners who live in dwellings such as high-rise apartments, for example, who can not always take a pet outside to relieve themselves.

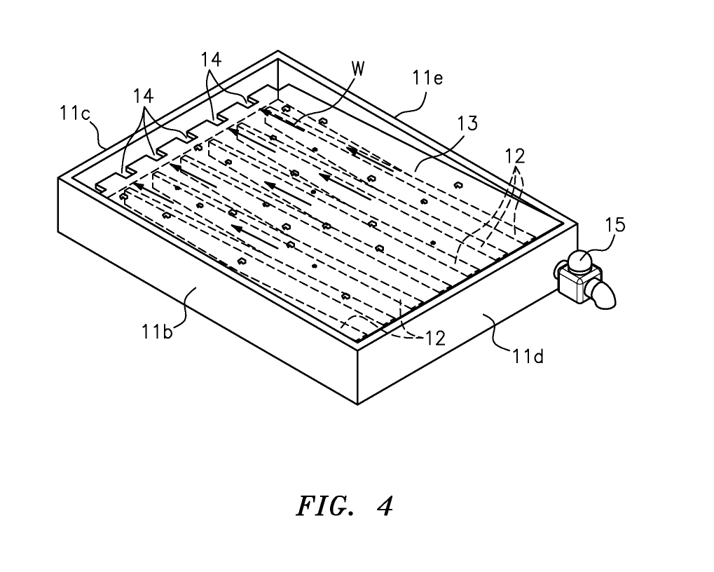

As illustrated in FIG. 4, when a pet such as a canine, for example, deposits liquid waste W onto the top surface 13, the angled slope Θ will direct the urine through the openings 14 and into the cavernous interior for storage. Then, at a desired time, the owner can deposit the stored waste W into a toilet or other such device via the drain 15.

Alternatively, when solid waste (i.e. feces) is deposited onto the top surface 13, it will remain in place until being removed by the owner in a conventional manner. However, owing to the non-porous makeup of the top surface 13, repeated feces deposits can be accomplished without staining or requiring the owner to remove parts for cleaning or otherwise rendering the top surface unsuitable for continued use.

As described herein, one or more elements of the pet waste collection device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the main body 11, the support rods 12, and/or the top surface 13 (including all subcomponents), for example, may be formed together as one continuous element, either through manufacturing processes, such as welding, casting, or molding, or through the use of a singular piece of material milled or machined with the aforementioned components forming identifiable sections thereof. Accordingly, in one alternate embodiment, each above described element of the pet waste collection device 10 can be constructed from injection molded plastic having a height and dimension suitable for use by pets of varying sizes.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A waste collection and storage device for pet deposits, comprising:
a main body having a generally planar base section and a plurality of side sections, each of said side sections having a generally orthogonal orientation to the base section;
a plurality of support columns uniformly positioned in a transverse manner on the base section, each of said support columns having a top surface positioned at a first angle;
a non-porous surface sheet secured to the top of the plurality of support columns at the first angle, said surface sheet having an upper edge and a lower edge positioned at opposite sides of the sheet;
a plurality of openings positioned along the periphery of the lower edge of the non-porous sheet, each of said openings being configured to allow liquid pet waste to be deposited into an interior portion of the main body for storage; and
a drain valve configured to allow the stored waste to be expelled from the device.

2. The waste collection and storage device of claim 1, wherein the first angle is 5 degrees.

3. The waste collection and storage device of claim 1, wherein the first angle is between substantially 1 and 20 degrees with respect to a perpendicular axis intersecting a side section of the main body.

4. The waste collection and storage device of claim 1, wherein each of the plurality of side sections include a height that is greater than a height of the non-porous sheet so as to define a raised lip around the periphery of the sheet.

5. The waste collection and storage device of claim 1, wherein the surface sheet is constructed from a non-porous, non-permeable material that includes at least one of PVC, Polymethyl methacrylate, and smooth plastic, having a low coefficient of friction.

6. The waste collection and storage device of claim 1, wherein the surface sheet is configured to collect solid waste without staining.

7. The waste collection and storage device of claim 1, wherein the main body is constructed from a single piece of aluminum material.

8. The waste collection and storage device of claim 1, wherein the main body is waterproof.

9. The waste collection and storage device of claim 1, wherein each of the main body, the plurality of support columns and the surface sheet include a unitary design formed from injection molded plastic.

10. The waste collection and storage device of claim 1, wherein the drain valve includes a removable plug.
